(19) United States
(12) Patent Application Publication
(10) Pub. No.: US 2009/0271785 A1
(43) Pub. Date: Oct. 29, 2009

(54) INFORMATION PROCESSING APPARATUS AND CONTROL METHOD

(75) Inventors: Kazuhiro Kawagome, Kokubungi-shi (JP); Hiroshi Nakajima, Nishitokyo-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/358,064

(22) Filed: Jan. 22, 2009

(30) Foreign Application Priority Data
Apr. 25, 2008 (JP) 2008-116120

(51) Int. Cl. G06F 9/455

(52) U.S. Cl. 718/1

(57) ABSTRACT

According to one embodiment, an information processing apparatus capable of controlling a plurality of operating systems, includes an activation module which activates an activation program, a management module which manages the plurality of operating systems to be activated by the activation module, a storage module which stores a main operating system that runs on the management module and a guest operating system that runs on the management module via a virtual activation program, and a notification module which, if a monitoring program that runs on the main operating system activated determines that a configuration of the information processing apparatus has changed, causes a notification program running on the main operating system to notify the guest operating system activated from the storage module via the virtual activation program of change information of the configuration of the information processing apparatus.

### CROSS-REFERENCE TO RELATED APPLICATIONS

This application is based upon and claims the benefit of priority from Japanese Patent Application No. 2008-116120, filed Apr. 25, 2008, the entire contents of which are incorporated herein by reference.

### BACKGROUND

1. Field

One embodiment of the present invention relates to an operating system virtualization technique and, more particularly, to an information processing apparatus capable of controlling hardware directly from a virtualized operating system and a control method.

2. Description of the Related Art

Generally, an information processing apparatus capable of controlling a plurality of operating systems (OSs) allocates internal hardware resources upon receiving activation requests for several OSs. In this case, the information processing apparatus allocates the hardware resources to the OSs to be activated based on the current hardware resource allocation state. For example, Jpn. Pat. Appln. KOKAI Publication No. 2008-33877 discloses a technique of allocating hardware resources to OSs to be activated based on architecture unique to the information processing apparatus.

However, the technique described in Jpn. Pat. Appln. KOKAI Publication No. 2008-33877, which allocates hardware resources to OSs to be activated based on architecture unique to the information processing apparatus, does not consider hardware resource allocation to OSs to be activated based on general-purpose architecture.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the arrangement of an information processing apparatus according to an embodiment of the present invention;

FIG. 2 is an exemplary block diagram showing the main components of the information processing apparatus according to the embodiment;

FIG. 3 is an exemplary flowchart for explaining the control method of the information processing apparatus according to the embodiment;

FIG. 4 is an exemplary flowchart for explaining the control method of the information processing apparatus according to the embodiment;

FIG. 5 is an exemplary conceptual view showing an arrangement including the position of a frame buffer on a main memory (memory space) in the management OS of the information processing apparatus according to the embodiment; and

FIG. 6 is an exemplary conceptual view showing an arrangement including the position of a frame buffer on a main memory (memory space) in the guest OS of the information processing apparatus according to the embodiment.

### DETAILED DESCRIPTION

Various embodiments according to the invention will be described hereinafter with reference to the accompanying drawings. In general, according to one embodiment of the invention, an information processing apparatus capable of controlling a plurality of operating systems, includes: an activation module which activates an activation program; a management module which manages the plurality of operating systems to be activated by the activation module; a storage module which stores a main operating system that runs on the management module and a guest operating system that runs on the management module via a virtual activation program; and a notification module which, if a monitoring program that runs on the main operating system activated from the storage module determines that a configuration of the information processing apparatus has changed, causes a notification program running on the main operating system to notify the guest operating system activated from the storage module via the virtual activation program of change information of the configuration of the information processing apparatus.

An embodiment of the present invention will now be described with reference to the accompanying drawing.

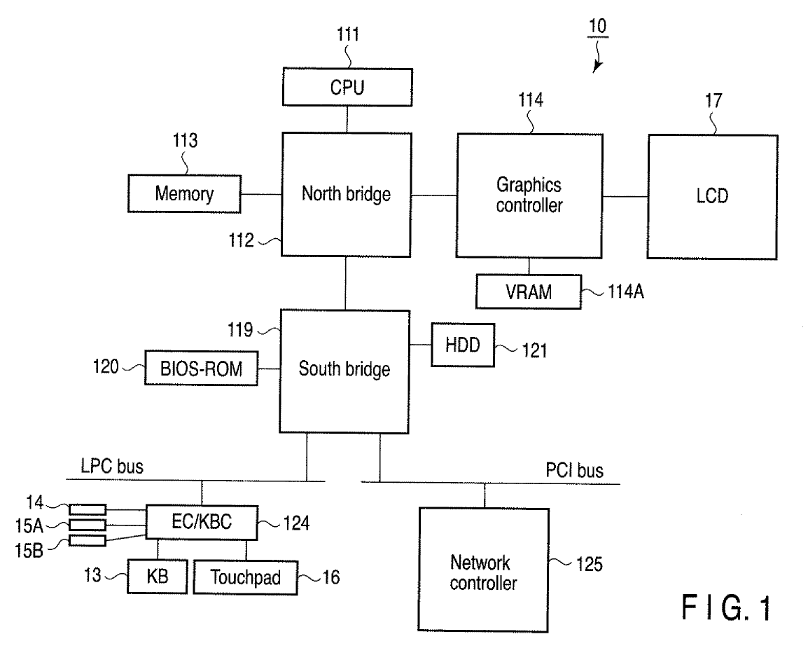

FIG. 1 is a block diagram showing the main parts of an information processing apparatus according to an embodiment, to which a control method of the present invention is applied. The information processing apparatus of the present invention is implemented as, e.g., a computer 10.

As shown in FIG. 1, the computer 10 includes a CPU 111, north bridge 112, memory 113, graphics controller 114, south bridge 119, BIOS-RON (to also be referred to as a BIOS hereinafter: activation program) 120, hard disk drive (HDD: storage module) 121, embedded controller/keyboard controller IC (EC/KBC) 124, and network controller 125.

The CPU 111 is a processor provided to control the operation of the computer 10 and executes an operating system (OS) and various application programs which are loaded from the hard disk drive (HDD) 121 to the memory 113.

The CPU 111 also executes a system Basic Input/Output System (BIOS) stored in the BIOS-ROM 120. The system BIOS is a program for hardware control.

The north bridge 112 is a bridge device for connecting the local bus of the CPU 111 to the south bridge 119. The north bridge 112 incorporates a memory controller to control access to the memory 113. The north bridge 112 also has a function of executing communication with the graphics controller 114.

The graphics controller 114 is a display controller that controls an LCD 17 serving as the display monitor of the computer 10. The graphics controller 114 generates, from image data written in a video memory (VRAM) 114A, a display signal to be sent to the LCD 17.

The south bridge 119 controls devices on a Low Pin Count (LPC) bus and devices on a Peripheral Component Interconnect (PCI) bus. The south bridge 119 incorporates an Integrated Drive Electronics (IDE) controller to control the HDD 121 and the like.

The HDD 121 is a storage device for storing various kinds of OSs and software.

The embedded controller/keyboard controller IC (EC/KBC) 124 is a one-chip microcomputer on which an embedded controller for power management and a keyboard controller to control a keyboard (KB) 13 and a touchpad 16 are integrated. The network controller 125 is a communication device which executes communication with an external network such as the Internet.

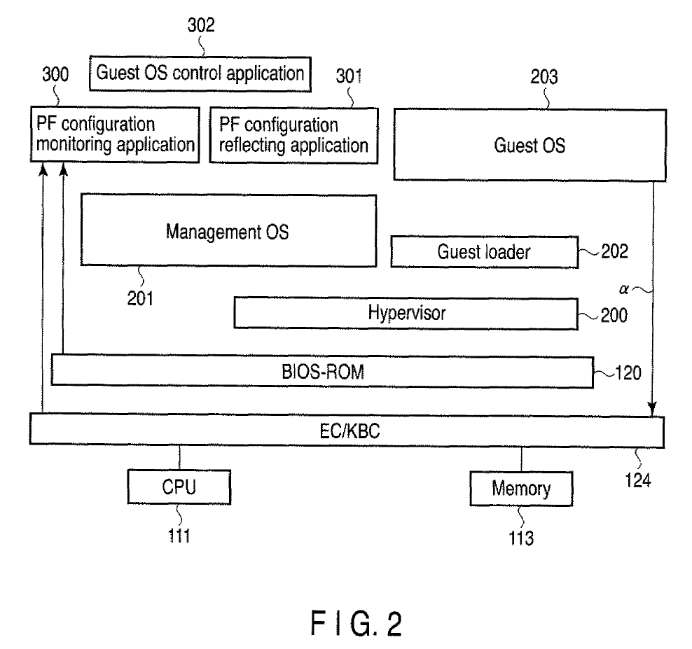

As shown in FIG. 2, the information processing apparatus 10 of this embodiment has a virtual environment where a plurality of OSs can be activated. In this embodiment, an example will be described in which two OSs (a management OS 201 and a guest OS 203) are activated and controlled. However, the present invention is not limited to this and is also applicable to a case in which three or more OSs are activated and controlled.

The computer 10 activates the BIOS-ROM 120 first, and then sequentially activates a hypervisor (management module) 200, the management OS 201, various applications (e.g., a platform configuration monitoring application 300, a platform configuration reflecting application 301, and a guest OS control application 302) which run on the management OS, a guest loader (virtual activation program) 202, and the guest OS 203.

The hypervisor 200 is a basic program that controls a plurality of OSs. The management OS 201 is the main OS of the OSs activated on the computer 10. The various applications (e.g., the platform (PF) configuration monitoring application 300, platform configuration reflecting application (notification module: notification program) 301, and guest OS control application 302) running on the management OS check the configuration of the platform at the time of activation of the computer 10, and if a change is detected, notify it. They also activate the guest loader 202. The guest loader 202 is a virtual BIOS which activates the guest OS 203 upon receiving an instruction from the guest OS control application 302 or the like. The guest loader 202 has table data including the configuration information of the platform of the computer 10.

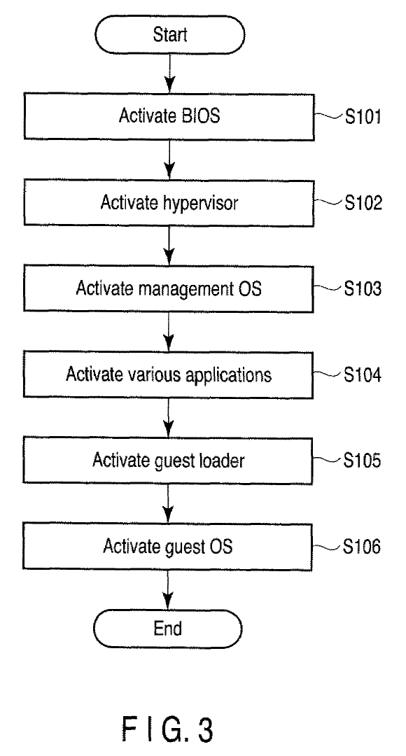

A control method using the information processing apparatus according to the embodiment of the present invention with the above-described arrangement will be described next with reference to the flowchart in FIG. 3.

When the computer 10 is powered on, the BIOS 120 is activated (block S101). The activated BIOS 120 activates the hypervisor 200. The activated hypervisor 200 activates the management OS 201 (block S103). When the management OS 201 is activated, various applications that run on the management OS 201 are activated (block S104). The various applications that run on the management OS 201 includes, e.g., the platform configuration monitoring application 300, platform configuration reflecting application 301, and guest OS control application 302. Next, the guest OS control application 302 activates the guest loader 202 (block S105). The activated guest loader 202 activates the guest OS 203 (block S106).

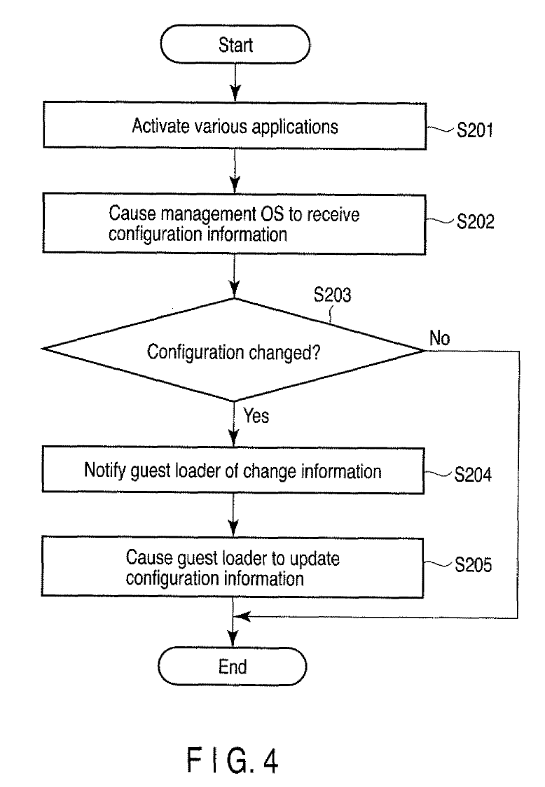

Processing of checking the configuration of the platform of the computer 10 at the time of its activation will be described next with reference to the flowchart in FIG. 4.

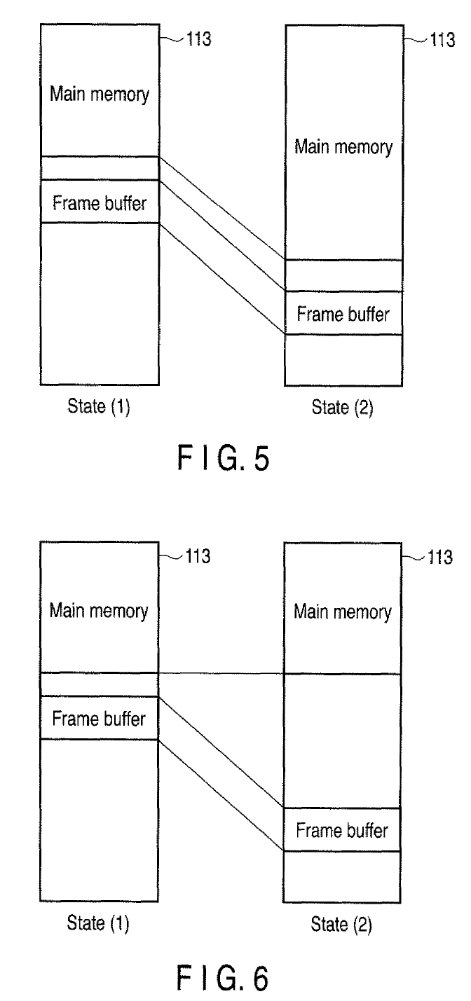

When various applications that run on the management OS 201 are activated (block S201), the management OS 201 reads and receives table data which includes the configuration information of the platform of the computer 10 and is stored in the BIOS-ROM 120 (block S202). The platform configuration monitoring application 300 checks based on the table data received by the management OS 201 whether the configuration of the platform of the computer 10 has changed (block S203). If the platform configuration monitoring application 300 determines in block S203 that the configuration of the platform of the computer 10 has changed (YES in block S203), the platform configuration reflecting application 301 notifies the guest loader 202 of the change information (block S204). For example, the configuration of the platform of the computer 10 changes when the capacity of the memory 113 incorporated in the computer 10 is increased by, e.g., add-in by the user, as shown in FIGS. 5 and 6. As shown in FIG. 5, if the memory (main memory: memory space) 113 increases from state 1 to state 2, the frame buffer area moves from state 1 to state 2. The management OS (actual device) 201 reads and uses configuration information (state 1) stored in the BIOS-ROM 120. If the platform configuration monitoring application 300 detects the change of the configuration of the platform of the computer 10, it is necessary to update the configuration information (state 1) stored in the guest loader (virtual machine) 202 to the latest configuration information (state 2) to change the configuration information (including the position information of the frame buffer allocated on the main memory [memory space]) for the guest OS 203.

Upon receiving the change information, the guest loader 202 updates the table data, which is stored in itself and includes the configuration information of the platform of the computer 10, to the received update information (block S205: state 2 in FIG. 6). That is, the movement of the frame buffer position (the position information of the frame buffer allocated on the main memory) in the memory 113 is reflected. The activated guest OS can receive the configuration information (table data) from the guest loader 202 (using, e.g., command E820) and directly use the hardware resources of the computer 10 such as EC/KBC based on the received latest configuration information. Note that the capacity of the memory 113 in the virtual machine (guest OS 203) does not change, as indicated by state 2 in FIG. 6, because it is impossible to grasp add-in of the memory 113.

it is an object of the present invention to provide an information processing apparatus capable of allocating hardware resources to OSs to be activated based on general purpose architecture of an information processing apparatus and a control method.

The above-described processing allows a guest OS activated on a computer having general-purpose architecture to receive table data from the guest loader 202 and directly use the hardware resources of the computer 10, such as the EC/KBC, based on the latest configuration information of the platform of the computer 10. It is therefore possible to increase the process speed of the hardware resource use by the guest OS even in a computer having general-purpose architecture. Note that the above-described embodiment is applicable to a technique of moving the storage area of a frame buffer in accordance with a change of the (main) memory 113.

Note that the present invention is not exactly limited to the above embodiments, and constituent elements can be modified in the execution stage without departing from the spirit and scope of the invention.

Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus capable of controlling a plurality of operating systems, comprising:
an activation module which activates an activation program;
a management module which manages the plurality of operating systems to be activated by the activation module;
a storage module which stores a main operating system that runs on the management module and a guest operating system that runs on the management module via a virtual activation program; and
a notification module which, if a monitoring program that runs on the main operating system activated from the storage module determines that a configuration of the information processing apparatus has changed, causes a notification program running on the main operating system to notify the guest operating system activated from the storage module via the virtual activation program of change information of the configuration of the information processing apparatus.

2. The apparatus of claim 1, wherein the guest operating system directly accesses hardware of the information processing apparatus based on the received change information of the configuration of the information processing apparatus.

3. The apparatus of claim 1, wherein the monitoring program determines on the basis of configuration information of the information processing apparatus provided in the activation program whether the configuration of the information processing apparatus has changed.

4. The apparatus of claim 1, wherein the virtual activation program includes another configuration information of the information processing apparatus, which is different from the configuration information, and updates the configuration information based on the received change information.

5. The apparatus of claim 1, wherein the configuration information and said other configuration information include position information of a frame buffer allocated on a memory space provided in the information processing apparatus.

6. A control method used in an information processing apparatus capable of controlling a plurality of operating systems, comprising:
activating an activation program;
activating a management program which manages the plurality of operating systems to be activated by the activation program;
activating a main operating system that runs on the management program and a guest operating system that runs via a virtual activation program; and
if a monitoring program that runs on the activated main operating system determines that a configuration of the information processing apparatus has changed, causing a notification program running on the main operating system to notify the guest operating system activated from the storage module via the virtual activation program of change information of the configuration of the information processing apparatus.

7. The method of claim 6, wherein the guest operating system directly accesses hardware of the information processing apparatus based on the received change information of the configuration of the information processing apparatus.

8. The method of claim 6, wherein the monitoring program determines on the basis of configuration information of the information processing apparatus provided in the activation program whether the configuration of the information processing apparatus has changed.

9. The method of claim 6, wherein the virtual activation program includes another configuration information of the information processing apparatus, which is different from the configuration information, and updates the configuration information based on the received change information.

10. The method of claim 6, wherein the configuration information and said other configuration information include position information of a frame buffer allocated on a memory space provided in the information processing apparatus.
